(19) United States
(12) Patent Application Publication
(10) Pub. No.: US 2024/0196210 A1
(43) Pub. Date: Jun. 13, 2024

(54) SYSTEM AND METHOD FOR JOINING A SUBSCRIBER DEVICE TO A COMMUNICATIONS NETWORK

(71) Applicant: MOTOROLA SOLUTIONS, INC., CHICAGO, IL (US)

(72) Inventors: ERIC C ITTNER, DOWNERS GROVE, IL (US); JEFFREY F THURSTON, LAKE ZURICH, IL (US)

(21) Appl. No.: 18/065,099

(22) Filed: Dec. 13, 2022

(51) Int. Cl. H04W 12/06; H04W 60/04

(52) U.S. Cl. CPC H04W 12/06; H04W 60/04

(57) ABSTRACT

Techniques for joining a subscriber device to a communications network are provided. A first subscriber device that is registered with a communications network receives a request from a second subscriber device that is not registered with the communications network to join the communications network. The request is received over a wireless link. The first subscriber device sends a request to the communications network for authorization for the second subscriber device to join the communications network. The first subscriber device receives from the communications network authorization for the second subscriber device to join the communications network. The authorization includes a set of connection parameters. The first subscriber device sends the set of connection parameters to the second subscriber device, over the wireless link. The second subscriber device joins the communications network using the connection parameters.

### BACKGROUND

Emergency services agencies (e.g. police, fire, emergency medical services (EMS)) have a long tradition of providing assistance to other agencies, both near and far, when those agencies require resources beyond those which they have available. This tradition may generally be referred to as mutual aid. For example, when a major incident (e.g. hurricane, forest fire, building collapse, etc.) occurs, emergency services agencies may request and/or be offered assistance from other agencies who may not have been impacted by the incident and have resources to spare.

Establishing communications between the responders from the home agency (e.g. the location where the incident is occurring) and foreign responders (e.g. those responders providing mutual aid) has become easier with the establishment of mutual aid communications channels. The radio communications networks used by public safety agencies has become somewhat standardized. In the United States, most public safety agencies utilize Land Mobile Radio (LMR) networks that operate under the Project 25 (P25) standard. In other areas, the Terrestrial Trunked Radio (TETRA) system has achieved widespread adoption.

Due to the widespread adoption of standard radio networks, the communications devices (e.g. walkie-talkie, mobile radio, portable radio, etc.) carried by foreign responders will likely be compatible with the communications network infrastructure of the home agency. As such, the communications devices of the foreign responders may be programmed with information necessary to connect to a mutual aid communications channel of the radio network of the home agency. Likewise, the home radio network may be programmed to accept radios of foreign responders on a mutual aid channel. When an incident requiring mutual aid arises, the foreign responders can simply change to the mutual aid channel and begin communicating with responders from the home agency.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of a system in which the joining a subscriber device to a communications network techniques described herein may be implemented.

FIG. 2A is an example of a message sequence for joining a subscriber device when the authorization entity is another subscriber device.

FIG. 2B is an example of a message sequence for joining a subscriber device when the authorization authority is inherent in the home subscriber device.

FIG. 2C is an example of a message sequence for joining a subscriber device when the authorization entity is an external entity.

FIG. 3 is an example flow diagram of a home subscriber device assisting a foreign subscriber device in joining the communications network.

FIGS. 4A and 4B are an example flow diagram of the communications network assisting a foreign subscriber device in joining the network.

FIG. 5 is an example of a communication device that may implement the subscriber devices.

FIG. 6 is an example of a device that may implement the communications network infrastructure.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Although the existence of mutual aid channels may allow foreign radios to easily communicate using a home communications network, a problem arises in that both the foreign radio and the communications network require a level of pre-planning and configuration that must be done in advance of any incident that may require mutual aid.

As mentioned above, the foreign radio must be pre-configured with communications network parameters of the home system in order to allow the foreign radio to connect to the home communications network. This configuration information may be referred to as a code plug, and includes the information necessary for the foreign radio to connect (e.g. System ID, frequency information, etc.) to the home communications network. Similarly, the home communications network must be pre-configured with information about the foreign radio (e.g. Unit ID, Home system ID, etc.) before the foreign radio can be allowed to join the home communications network.

If the required information has not already been included in the code plug of the foreign radio and/or the home communications network, joining the foreign radio to the home communication network becomes a bit more difficult. The user associated with the foreign radio would typically be required to coordinate with the operator of the home communications network (e.g. an administrator of the home communications network, etc.) to obtain the necessary code plug information to configure the foreign radio.

It is most likely that this would require the foreign radio to be brought to the communications department (e.g. Information Technology department) of the home communications network for code plug configuration. The home communications network would need to be configured with information about the foreign radio. In the best case, this can be done at the same time the code plug is configured, but in some cases, this might require involvement of a different set of administrators that manage the home communications network. As should be clear, manually configuring a foreign radio to join a home communications network may be a tedious and time consuming process.

The techniques described herein resolve these problems individually and collectively. A user of a foreign radio may present himself to any user currently associated with a radio that has already joined the home communications network. The user of the foreign radio may then authenticate themselves to the home radio user. The authentication information may include that the foreign radio user has proper credentials (e.g. a law enforcement badge, driver's license etc.), is an authorized responder (e.g. wearing a proper uniform, etc.), and that the foreign radio is of a type that is allowed to connect to the home communications network (e.g. meets FCC requirements and/or not a cheap knock-off device).

Upon satisfaction that the foreign radio user is authentic and should be allowed to join the home communications, the home radio user may configure his device to create a short range wireless connection (e.g. Bluetooth, etc.) with the foreign radio. Part of this connection process may be providing a code to the user of the foreign radio device to enter as part of the connection process. This ensures that the wireless connection to the home radio is actually coming from the desired foreign radio, as any other device would not have the proper code.

The foreign radio may then send information about itself that is needed by the home communications network to allow the foreign radio to join the home communications network in a request to join the home communications network. The home radio may then forward this information to the communications network. Upon receiving this join request, the home communications network may, using one of several mechanisms, determine if the foreign radio is authorized to join the home communications network.

If the foreign radio device is authorized to join the home communications network, the home communications network sends parameters needed to join the home communications network (e.g. code plug configuration information) to the home radio. The home radio may then pass these parameters back to the foreign radio via the short range wireless connection. The foreign radio may then use the connection parameters to request to join the home communications network.

For example, consider a hurricane in the state of Florida. Such an incident may require a large scale response from foreign responders who may be from far away locations (e.g. different counties, different states, etc.). Because of the nature of the incident, foreign responders may be coming from far away areas and would not have been preconfigured to use the home communications network via mutual aid channels. Upon arrival at the incident area (e.g. the hurricane impacted area), the foreign responder need only locate any responder who has a radio that is already connected to the home communications network. The foreign radio user would not need to coordinate with the communications department of the home communications network.

A method is provided. The method includes receiving, at a first subscriber device, the first subscriber device registered with a communications network, a request from a second subscriber device to join the communications network, the second subscriber device not registered with the communications network, the request received via a wireless communications link. The method also includes sending, by the first subscriber device, a request to the communications network for authorization for the second subscriber device to join the communications network. The method also includes receiving, by the first subscriber device, from the communications network an authorization for the second subscriber device to join the communications network, the authorization including a set of connection parameters for joining the communications network. The method also includes sending, by the first subscriber device, the set of parameters for joining the communications network to the second subscriber device, over the wireless link, wherein the second subscriber device uses the set of connection parameters to join the communications network.

In one aspect, the method further includes authenticating the second subscriber device prior to receiving the request to join the communications network from the second subscriber device. In one aspect of the method, authenticating the second subscriber device further comprises authenticating a user of the second subscriber device. In one aspect of the method, the request from the second subscriber device to join the communications network includes at least one of a unit ID, a home system ID, and a role of a user of the second subscriber device.

In one aspect of the method, the set of connection parameters includes a default talkgroup, the default talkgroup based on a role of a user of the second subscribed device. In one aspect of the method, the request to the communications network for authorization for the second subscriber device to join the communications network indicates to the communications network that the second subscriber device is authorized to join the communications network. In one aspect of the method, the second subscriber device is not registered with any communications network.

A method is provided. The method includes receiving, at a communications network, a request from a first subscriber device to provide a set of connection parameters to be utilized by a second subscriber device to join the communications network. The method also includes determining if the second subscriber device is authorized to join the communications network. The method also includes sending the set of connection parameters to the first subscriber device when it is determined that the second subscriber device is authorized to join the communications network, wherein the second subscriber device utilizes the set of connection parameters to join the communications network.

In one aspect of the method, determining if the second subscriber device is authorized to join the communications network further comprises sending an approval request to a third subscriber device, the third subscriber device associated with a user having a supervisory role and receiving a response from the third subscriber device, the response indicating if the second subscriber device is authorized to join the communications network. In one aspect of the method, determining if the second subscriber device is authorized to join the communications network further comprises determining if the first subscriber device is associated with a user that is authorized to approve subscriber devices joining the communications network and authorizing the second subscriber device to join the communications network when it is determined that the user associated with the first subscriber device is authorized to approve subscriber devices joining the communications network.

In one aspect of the method determining if the second subscriber device is authorized to join the communications network further comprises sending an approval request to a third party authorization entity and receiving a response from the third party authorization entity, the response indicating if the second subscriber device is authorized to join the communications network. In one aspect of the method, the request from first subscriber device to provide the set of connection parameters to be utilized by a second subscriber device to join the communications network further comprises a role of a user associated with the second subscriber device and the set of connection parameters further comprises a default talkgroup for the user associated with the second subscriber device, the default talkgroup based on the role of the user associated with the second subscriber device. In one aspect of the method, the set of connection parameters further comprises a subscriber ID associated with the communications network that is to be used by the second subscriber device when joining the communications network.

A non-transitory processor readable medium is provided. The medium contains a set of instructions thereon the when executed by a processor casue the processor to receive, at a first subscriber device, the first subscriber device registered with a communications network, a request from a second subscriber device to join the communications network, the second subscriber device not registered with the communications network, the request received via a wireless communications link. The instructions further cause the processor to send, by the first subscriber device, a request to the communications network for authorization for the second subscriber device to join the communications network. The instructions further cause the processor to receive, by the first subscriber device, from the communications network an authorization for the second subscriber device to join the communications network, the authorization including a set of connection parameters for joining the communications network. The instructions further cause the processor to send, by the first subscriber device, the set of parameters for joining the communications network to the second subscriber device, over the wireless link, wherein the second subscriber device uses the set of connection parameters to join the communications network.

In one aspect the medium further comprises instructions to authenticate the second subscriber device prior to receiving the request to join the communications network from the second subscriber device. In one aspect of the medium, wherein authenticating the second subscriber device further comprises instructions to authenticate a user of the second subscriber device. In one aspect of the medium the request from the second subscriber device to join the communications network includes at least one of a unit ID, a home system ID, and a role of a user of the second subscriber device.

In one aspect of the medium, the set of connection parameters includes a default talkgroup, the default talkgroup based on a role of a user of the second subscribed device. In one aspect of the medium, the request to the communications network for authorization for the second subscriber device to join the communications network indicates to the communications network that the second subscriber device is authorized to join the communications network. In one aspect of the medium, the second subscriber device is not registered with any communications network.

Further advantages and features consistent with this disclosure will be set forth in the following detailed description, with reference to the figures.

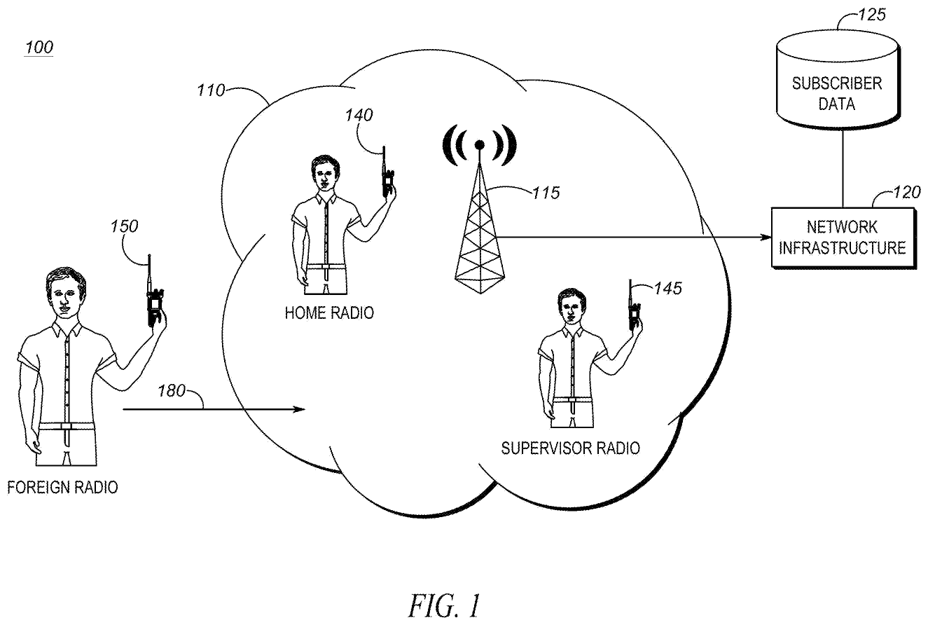

FIG. 1 is an example of a system 100 in which the joining a subscriber device to a communications network techniques described herein may be implemented. The system includes a home communications network 110 which is generally a geographic area where radio communications is provided. The home communications network 110 may include a Radio Access Network (RAN) 115 which provides radio frequency (RF) coverage to subscriber devices located within the coverage area of the home communications network.

The home communications network may also include network infrastructure 120 which may control the non RF functions of the home communications network 110. For example, the network infrastructure 120 may control functions of the home communications network (e.g. controlling the RAN, authorizing subscriber devices, etc.). The network infrastructure may also include subscriber data 125, which may store information related to subscriber devices that are allowed to join the home communications network 110. Examples of such information is provided in further detail below.

What should be understood is that regardless of the particular standard for the communications network (e.g. P25, TETRA, etc.) each system will include components for allowing wireless communications. For example, a P25 communications network may include one or more RF sites, console sites, a packet data core, interoperability systems to communicate with other communications systems, etc. Regardless of the type of system, there will be a data store that includes information about all subscriber devices that are able to join the communications network.

The system 100 may include at least one home radio 140, which may also be referred to as a subscriber device. The home radio 140 may be any type of device that is currently joined to the home communications network. Examples of such devices can include fixed radio devices (e.g. consoles, etc.), mobile devices (e.g. vehicle mounted radios, etc.), and portable devices (e.g. walkie-talkies, etc.). It should be understood that a radio is generally any device that is able to join and communicate using the home communications network 110.

The system 100 may also include a supervisor radio 145. The supervisor radio 145 is generally the same as the home radio 140, with the exception that a user associated with the supervisor radio 145 is authorized to determine if a foreign radio 150 should be allowed to join the home communications network 110. The user of the home radio 140 and the user of the supervisor radio 145 are able to communicate with each other via the home communications network 110.

The system 100 may also include a foreign radio 150. The foreign radio 150 may be a radio that is compatible with the home communications network 110, but is not currently configured to join the home communications network. For example, the home communications network 110 may be a network that utilizes the P25 architecture and the foreign radio 150 is a P25 compatible radio. However, the foreign radio code plug may not be configured to operate on the home communications network 110 and the subscriber data 125 may not include information related to the foreign radio 150.

In operation, an incident requiring aid from foreign responders may occur. For example, a hurricane in Florida may utilize foreign responders coming from different states. When the user of the foreign radio 150 moves 180 into the coverage area of the home communications network 110, he may wish to cause the foreign radio 150 to join the home communications network in order to allow radio communications between the foreign radio and the home radio 140 as well as any other radios that are currently joined to the home communications network. The process of joining the foreign radio 150 to the home communications network 110 is described in further detail below.

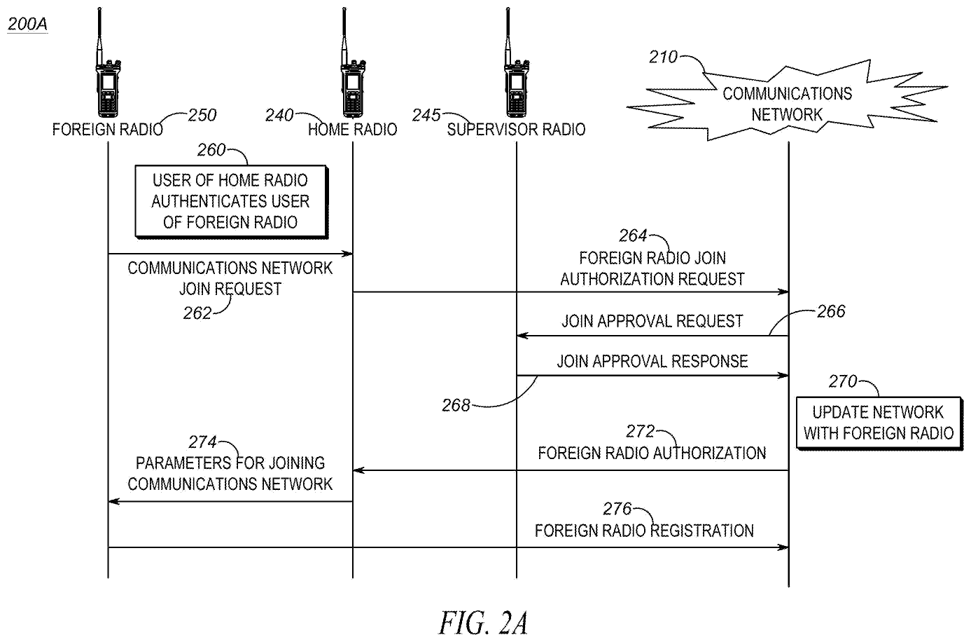

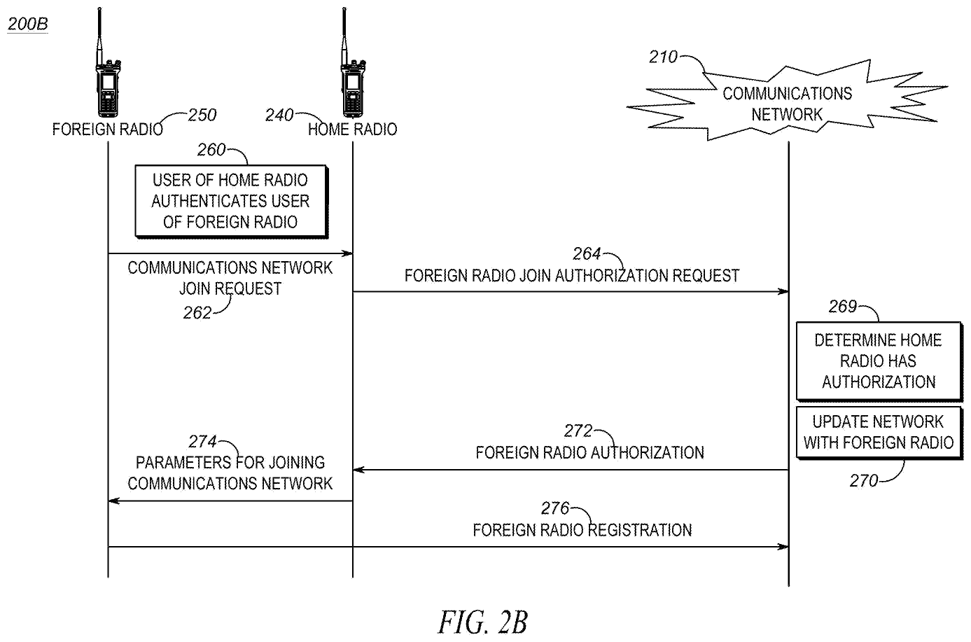

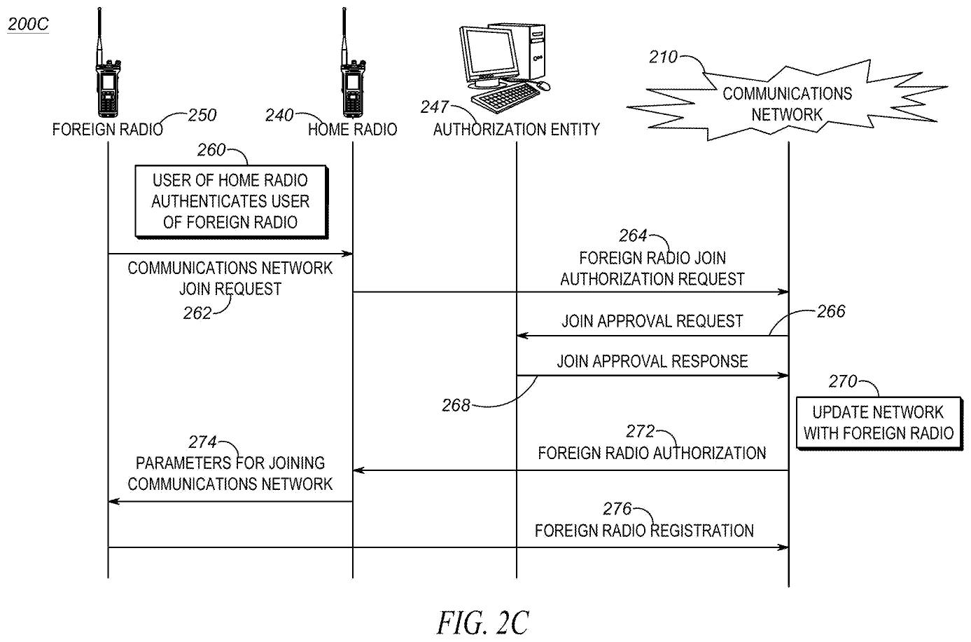

FIG. 2A is an example of a message sequence 200A for joining a subscriber device when the authorization entity is another subscriber device. The message sequence diagram includes a home communications network 210, a home radio 240, a supervisor radio 245, and a foreign radio 250. Each of these elements is substantially the same as the like numbered element from FIG. 1. Initially, the foreign radio 250, which may also be referred to as a subscriber device, is not registered (e.g. joined) to the communications network 210 but may wish to join (e.g. to provide mutual aid, etc.). Although not shown, it should be understood that there is a human user associated with each of the radios described with respect to FIGS. 2A-2C.

The user of the foreign radio 250 may approach the user of the home radio 240 and request to join the communications network. Prior to any communications between the radios, the user of the home radio 240 may authenticate 260 the user of the foreign radio 250 to determine if the user of the foreign radio 250 is truly a bona fide foreign responder who actually has a reason to join the home communications network 210. For example, the user of the home radio 240 may check the identification credentials of the foreign responder, may ensure that the foreign responder is in a proper uniform, has radio equipment that is authorized to connect to the home communications network 210, is acting as a foreign responder to an ongoing incident, etc. In other words, the home user verifies that the foreign user is not an imposter attempting to fraudulently connect to the home communications network 210 for some unknown reason.

Once the user of the home radio 240 is satisfied that the foreign radio 250 should be allowed to join the home communications network 210, the home user may launch a connection application on the home radio to allow a short range wireless connection between the home radio and the foreign radio to be created. An example of such a wireless connection may include a connection using any of the numerous varieties of Bluetooth that are available. However, it should be understood that the techniques described herein are not limited to any particular type of short range wireless communications technologies. Other examples may include Near Field Communications (NFC), Wi-Fi, ZigBee, or any other technology that may be used for wireless communications between two devices.

As part of the connection process, the foreign radio 250 may be asked to authenticate itself as being authorized to connect to the home radio 240. For example, the connection application on the home radio 240 may generate a numeric code or some other type of password. The home user then provides this password to the foreign user to type into the foreign radio 250 that is attempting to connect to the home radio 240. Use of such a code or password prevents an unknown device from connecting to the home radio 240, because such unknown device would not have the correct code. In short, the home radio 240 is able to confirm that the foreign radio 250 is actually the radio associated with the foreign user that was authenticated in step 260.

Once the foreign radio 250 and the home radio 240 are connected via the short range wireless connection, the foreign radio may send a communications network join request 262 message to the home radio. The communications network join request 262 may include information needed by the home communications network (e.g. data that needs to be stored in the subscriber data 125, etc.) 210 in order to allow the foreign radio 250 to join. Examples of such information can include a Unit ID of the foreign radio that identifies the foreign radio so that it can be communicated with, the home system ID, which provides information about which home system the foreign radio belongs to, a role of the user of the foreign radio (e.g. police, fire, EMS, etc.), and any other information needed by the home communications network 210. As explained above, the radio networks used by public safety agencies have become somewhat standardized, and the connection parameters that are needed are known (although dependent on the particular type of communications network (e.g. P25, TETRA, etc.)).

The home radio 240 may then send a foreign radio join authorization request 264, via an over the air (OTA) control channel, to the communications network 210. The authorization request 264 may include the information that was received from the foreign radio in the join request 262. The OTA control channel may be a channel for sending non-voice control information between the communications network 210 and the radios (e.g. subscriber devices). The OTA control channels may be used for transmitting information that is needed to configure both the communications network 210 and the foreign radio 250 with parameters (e.g. code plug information) needed to join the communications network.

The communications network 210 may then send a join approval request 266 to an entity that is authorized to grant a join request. In the example shown in FIG. 2A, the join approval request 266 may be sent to a supervisor radio 245 that is associated with a supervisory user. For example, a supervisor of the user of home radio 240. The join approval request may be sent over an OTA control channel. FIGS. 2B and 2C depict alternate examples of techniques for getting approval for the foreign radio 250 to join the home communications network 210.

Upon receiving the join approval request 266, the user of the supervisor radio 245 may determine if the join approval request should be allowed. The supervisor may have additional information not available to the user of the home radio 240. For example, the supervisor may know how many foreign responders are currently available and if any more are actually needed. The supervisor may also determine if there is a reason this particular foreign responder should not be allowed to join (e.g. jurisdictional conflicts, previous issues, etc.). What should be understood is that the user of the supervisor radio 245 may determine if the foreign radio 250 should be allowed to join the communications network 210 or not.

The user of the supervisor radio may then cause a join approval response 268 to be sent to the communications network. In some implementations (not shown) if the join approval request is not approved, the reason why the request was not approved may be returned to the user of the home radio 240 to convey the reason the reason to the user of the foreign radio 250. Assuming the join approval response 268 indicates that the join approval request has been approved, the information about the foreign radio 250 that was received in the join request 262 may be used to update the network with the foreign radio 270. For example, the information may be stored in the subscriber data 125 in order to allow the network to communicate with the foreign radio 250.

Assuming the join request was approved, the home communications network 210 may send a foreign radio join authorization 272 back to the home radio 240. The foreign radio join authorization 272 may include connection parameters (e.g. code plug information) that would allow the foreign radio 250 to join the home communications network 210. Examples of such parameters may include a system ID of the home communications network 210, RAN site access information (e.g. site IDs, frequency information, wide area connection ID (WacnID), a foreign radio user ID (e.g. a unit ID that the foreign radio should use while connected to the home communications network), and any other information that would be needed to be programmed into the foreign radio's 250 code plug in order to connect to the home communications network.

Upon receipt of the foreign radio join authorization 272, the home radio 240 may send, via the short range wireless connection between the home radio and the foreign radio 250, the connection parameters for joining the communications network 274 to the foreign radio. As explained above, the connection parameters are the information that needs to be configured within the foreign radio's 250 code plug in order to join the home communications network.

Upon receipt of the parameters for joining the communications network 274, the foreign radio may update its code plug with the received parameters. The foreign radio may then send a foreign radio registration 276 message, via the RAN, to the home communications network 210. The home communications network 210 had previously stored the information from the foreign radio 250 that was received in the foreign radio join authorization request 264 and as such the home communications network is already aware of the foreign radio 250. The home communications network 210 may then allow the foreign radio 250 to join the home communications network.

At this point the foreign radio 250 has joined the home communications network 210 and can behave like any other radio connected to the home communications network. For example, making calls to other radios on the home communications network, participating in talkgroups, getting additional RAN related information (e.g. adjacent RF sites, etc.), availability of additional local talkgroups, etc.

FIG. 2B is an example of a message sequence 200B for joining a subscriber device when the authorization authority is inherent in the home subscriber device. The majority of the message sequence depicted in FIG. 2B is the same as what was described with respect to FIG. 2A and will not be repeated here for ease of description.

In FIG. 2B, when the home communications network receives the foreign radio join authorization request 264, the home communications network may determine that the home radio has authorization 269 to allow foreign radio 250 to join the communications network 210. For example, the home radio 240 may be associated with a user that is a supervisor and as such is allowed to grant join requests from foreign radio 250. As another example, certain individuals may be assigned the task of assisting foreign radios 250 joining the communications network 210 and those individual's associated radios 240 may be designated as radios that can bypass any additional approval processing of join requests.

FIG. 2C is an example of a message sequence 200C for joining a subscriber device when the authorization entity is an external entity. The majority of the message sequence depicted in FIG. 2C is the same as what was described with respect to FIG. 2A and will not be repeated here for ease of description.

The difference between the message sequence shown in FIG. 2A and the one shown in FIG. 2C is that the supervisor radio 245 has been replaced with an authorization entity 247. The authorization entity 247 could be any type of entity that may be used to approve a foreign radio 250 joining the communications network 210. For example, for a major incident, a command center may be set up, and personnel at the command center may be given the authority to determine which radios are allowed to join the home communications network 210. As yet another example, the authorization entity may be a dispatcher operating a dispatch console. The dispatcher may not be a supervisor, but has been granted the authority to approve join requests.

As yet another example, the authorization entity 247 may be a credential verification service that verifies the foreign radio 250 should be allowed to join the communications network 210. What should be understood is that the device approving joining the foreign radio 250 need not be another radio.

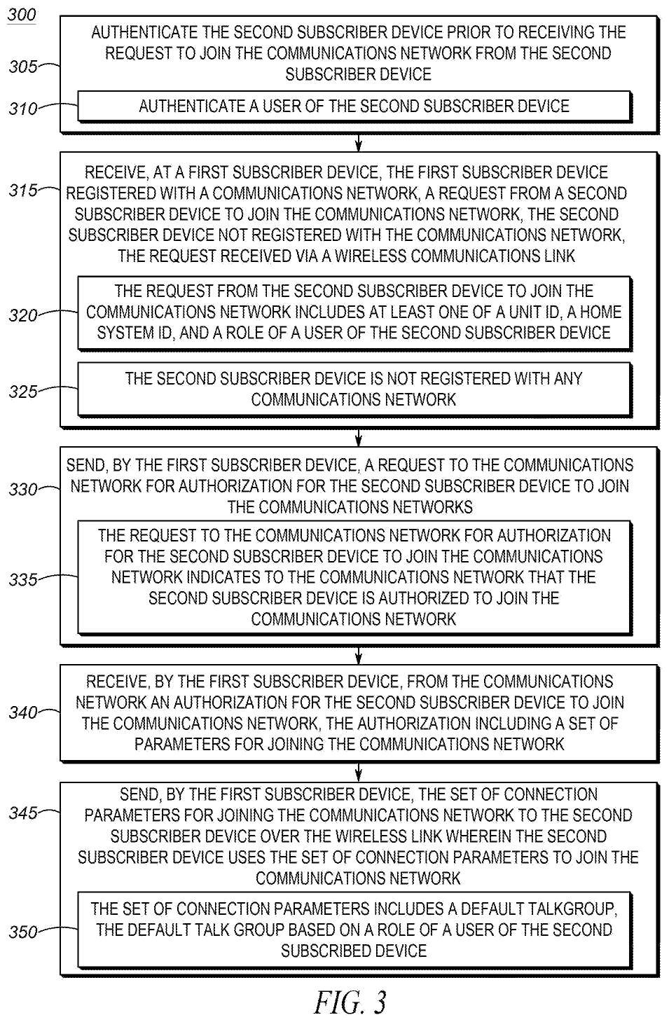

FIG. 3 is an example flow diagram 300 of a home subscriber device assisting a foreign subscriber device in joining the communications network. In block 305, the second subscriber device may be authenticated prior to receiving the request to join the communications network from the second subscriber device. As explained above, before any steps are taken to actually join the foreign radio (e.g. the second subscriber device) to the communications network, the second subscriber device may be verified by the home radio user to be a suitable device for connection to the home communications network (e.g. the communications network).

In block 310, authenticating the second subscriber device further includes authenticating a user of the second subscriber device. The user of the second subscriber device may be authenticated by ensuring he has the correct credentials (e.g. badge, uniform, etc.) and is truly a legitimate foreign responder. This is done to ensure that there is not a bad actor attempting to join the communications network and that the request to join the network is truly for legitimate mutual aid for a foreign responder.

In block 315, a request from the second subscriber device to join the communications network may be received at a first subscriber device (e.g. home radio) that is registered (e.g. joined, connected, etc.) to the communications network. The second subscriber device is not registered with the communications network and the request is received via a wireless communications link. In this block the second subscriber device is sending a request to join the communications network. The first subscriber device need not have any particular authority, other than having already been connected to the communications network, thus making it easier for a foreign radio to join as they can utilize any home radio.

The second subscriber device is not registered with the communications network, meaning that the second subscriber device has no connection information stored in the communications network (e.g. the subscriber data 125). As described above, the request to join may be received over a short range wireless communications link between the first and second subscriber devices that was previously authenticated (e.g. code passed from home user to foreign user).

In block 320 the request from the second subscriber device to join the communications network includes at least one of a unit ID, a home system ID, and a role of a user of the second subscriber device. This information is provided so that the communication network is able to store information about the second subscriber device. The role of the user (e.g. police, fire, EMS) may be provided so that when the second subscriber device actually joins the communications network, he may be included in default talkgroups associated with his role. For example, a foreign user who is a police officer may be included in the police officer default talkgroup of the communications network in order to facilitate communication with other responders who are also assigned the role of police officer.

In block 325, the second subscriber device is not registered with any communications network. Although the description up till now assumes that the second subscriber device is already configured to operate with a foreign communications network, the techniques described herein are not so limited. A brand new out of the box radio may not be currently configured to be registered with any communications network. The techniques described here could be utilized to provide configuration information for brand new radios, as well as radios from foreign systems.

In block 330, the first subscriber device (e.g. home radio) may send a request to the communications network for authorization for the second subscriber device to join the communications network. The request to join the communications network may include the information that was provided from the second subscriber device to the first subscriber device. This information may eventually be stored in the subscriber data of the communications network.

In block 335, the request to the communications network for authorization for the second subscriber device to join the communications network indicates to the communications network that the second subscriber device is authorized to join the communications network. As explained above, in some implementations, the mere fact that the join request has come from a particular subscriber device (e.g. an authorized device) is sufficient to determine the second subscriber device is authorized to join the communications network.

In block 340, the first subscriber device may receive from the communications network an authorization for the second subscriber device to join the communications network. The authorization including a set of connection parameters for joining the communications network. For example, the connection parameters may be information that needs to be programmed into the code plug of the second subscriber device in order for the second subscriber device to join the communications network.

In block 345, the first subscriber device may send the set of parameters for joining the communications network to the second subscriber device over the wireless link. The second subscriber device may use the set of connection parameters to join the communications network. For example, the second subscriber device may use the set of connection parameters to program the code plug of the second subscriber device with the correct configuration information for connecting to the communications network.

In block 350, the set of connection parameters includes a default talkgroup, the default talkgroup based on a role of a user of the second subscribed device. As explained above, talkgroups may be groups of users with the same and/or similar roles. By providing a default talkgroup based on the role of the user of the second subscriber device, the user of the second subscriber device can be connected with other responders that are associated with the role of the foreign responder.

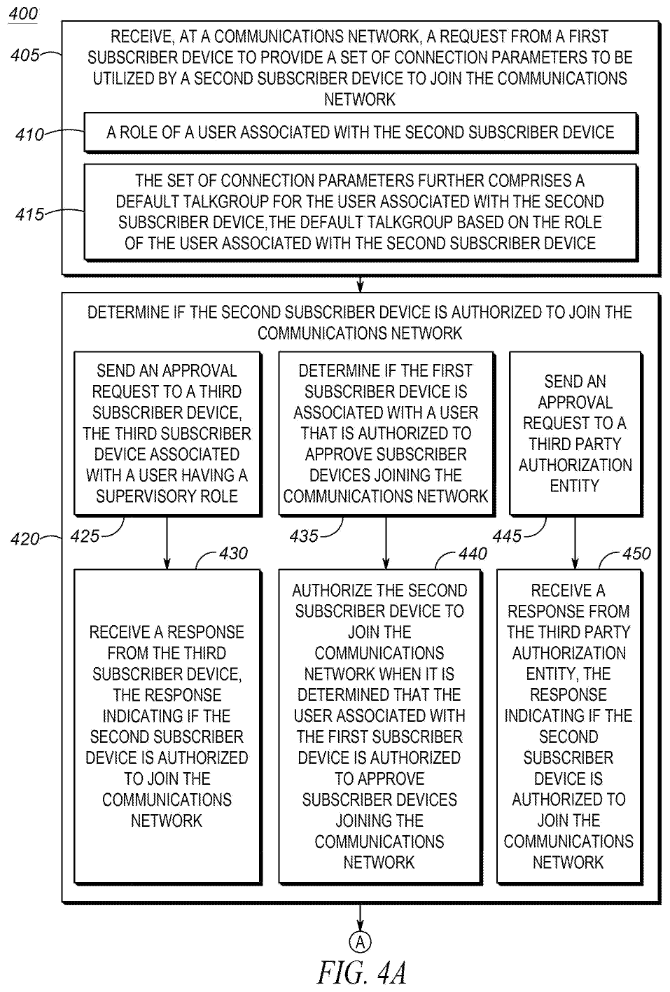

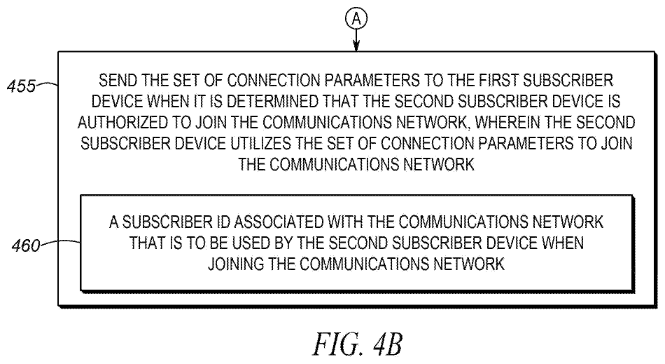

FIGS. 4A and 4B are an example flow diagram 400 of the communications network assisting a foreign subscriber device in joining the network. In block 405, a request from a first subscriber device to provide a set of connection parameters to be utilized by a second subscriber device to join the communications network may be received at a communications network. Once the second subscriber device (e.g. foreign radio) has communicated with the first subscriber device (e.g. home radio) to begin the process of joining the communications network, the first subscriber device sends that request to the communications network.

In block 410, the request from first subscriber device to provide the set of connection parameters to be utilized by a second subscriber device to join the communications network further comprises a role of a user associated with the second subscriber device. The user associated with the second subscriber device is a foreign responder that has an assigned role (e.g. police, fire, EMS). That role may be used by the communications network when creating the set of connection parameters for the second subscriber device.

In block 415, the set of connection parameters further comprises a default talkgroup for the user associated with the second subscriber device, the default talkgroup based on the role of the user associated with the second subscriber device. By providing a default talkgroup, the user of the second subscriber device is able to communicate with others in the communication network that are assigned to the same role.

In block 420, it may be determined if the second subscriber device is authorized to join the communications network. Just because the second subscriber device (e.g. foreign radio) desires to join the communications network does not mean it should automatically be allowed to join. As explained above, there may be certain conditions where it might be preferred to not allow the second subscriber device to join the communications network (e.g. sufficient numbers of foreign responders are already available, etc.). Three general mechanisms for receiving approval are described.

In the first mechanism, approval is received from a supervisor radio that is associated with a supervisor user. In block 425, an approval request may be sent to a third subscriber device, the third subscriber device associated with a user having a supervisory role. The supervisor may have been given the authority to decide which foreign radios are/are not allowed to join the communications network. The supervisor may use a user interface on the supervisor radio to indicate if the join request for the second subscriber device is approved or not.

In block 430, a response may be received from the third subscriber device, the response indicating if the second subscriber device is authorized to join the communications network. In other words, the decision from the supervisor to allow or deny the second subscriber device to join the network is received by the communications network from the supervisor's radio.

In the second mechanism, it is determined if the first subscriber device itself is a device that is authorized to approve join requests. In block 435, it may be determined if the first subscriber device is associated with a user that is authorized to approve subscriber devices joining the communications network. For example, if the first subscriber device is associated with a user with supervisor authority, the fact that the request is coming from a supervisor may be sufficient for approving the join request. In some implementations, certain subscriber devices may have been pre-configured as subscriber devices that are allowed to approve join requests from foreign radios.

In block 440, the second subscriber device may be authorized to join the communications network when it is determined that the user associated with the first subscriber device is authorized to approve subscriber devices joining the communications network. In other words, if the join request came from a subscriber device that is authorized to approve join requests, the request can be automatically approved. The reason for this being, if the second subscriber device was not going to be allowed to join the network, the user of the first subscriber device would have rejected the request at a much earlier stage (e.g. while authenticating the user of the foreign radio).

In the third mechanism, approval is received from an authorization entity that is not a radio. In block 445, an approval request is sent to a third party authorization entity. The third party authorization may be a dispatcher at a dispatch console, an incident command center, or any other entity that is not a subscriber device.

In block 450, a response is received from the third party authorization entity, the response indicating if the second subscriber device is authorized to join the communications network. Just as in the previous mechanism, it is determined if the second subscriber device should be allowed to join the communications network.

In block 455, the set of connection parameters may be sent to the first subscriber device when it is determined that the second subscriber device is authorized to join the communications network, wherein the second subscriber device utilizes the set of connection parameters to join the communications network. For example, the set of connection parameters may be the configuration information that needs to be programmed into the code plug of the second subscriber device in order to connect to the communications network.

In block 460, the set of connection parameters may include a subscriber id associated with the communications network that is to be used by the second subscriber device when joining the communications network. When the foreign radio is connected to the communications network it might not be able to use its own subscriber ID, as that ID may already be in use in the communications network. The connection parameters can include a subscriber ID that is not already in use in the communications network that the second subscriber device can use while joined to the communications network.

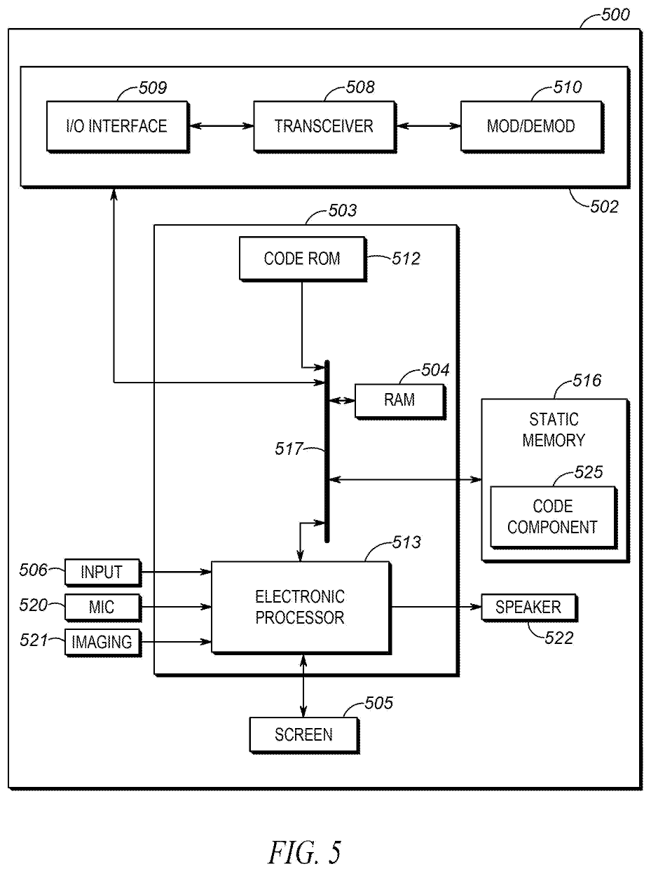

FIG. 5 is an example of a communication device 500 that may implement the subscriber devices. The communication device 500 may be, for example, embodied in the home radio 140, the supervisor radio 145, the foreign radio 150, and the authorization entity 247. The communication device 500 may be a distributed communication device across two or more of the foregoing (or multiple of a same type of one of the foregoing) and linked via a wired and/or wireless communication link(s). In some embodiments, the communication device 500 (for example, the home radio 140) may be communicatively coupled to other devices such as the foreign radio 150.

While FIG. 5 represents the communication devices described above with respect to FIG. 1, depending on the type of the communication device, the communication device 500 may include fewer or additional components in configurations different from that illustrated in FIG. 5. For example, in some embodiments, communication device 500 acting as the infrastructure may not include one or more of the screen 505, input device 506, microphone 520, imaging device 521, and speaker 522. As another example, in some embodiments, the communication device 500 acting as the radio may further include a location determination device (for example, a global positioning system (GPS) receiver). Other combinations are possible as well.

As shown in FIG. 5, communication device 500 includes a communications unit 502 coupled to a common data and address bus 517 of a processing unit 503. The communication device 500 may also include one or more input devices (e.g., keypad, pointing device, touch-sensitive surface, etc.) 506 and an electronic display screen 505 (which, in some embodiments, may be a touch screen and thus also act as an input device 506), each coupled to be in communication with the processing unit 503.

The microphone 520 may be present for capturing audio from a user and/or other environmental or background audio that is further processed by processing unit 503 in accordance with the remainder of this disclosure and/or is transmitted as voice or audio stream data, or as acoustical environment indications, by communications unit 502 to other portable radios and/or other communication devices. The imaging device 521 may provide video (still or moving images) of an area in a field of view of the communication device 500 for further processing by the processing unit 503 and/or for further transmission by the communications unit 502. A speaker 522 may be present for reproducing audio that is decoded from voice or audio streams of calls received via the communications unit 502 from other portable radios, from digital audio stored at the communication device 500, from other ad-hoc or direct mode devices, and/or from an infrastructure RAN device, or may playback alert tones or other types of pre-recorded audio.

The processing unit 503 may include a code Read Only Memory (ROM) 512 coupled to the common data and address bus 517 for storing data for initializing system components. The processing unit 503 may further include an electronic processor 513 (for example, a microprocessor or another electronic device) coupled, by the common data and address bus 517, to a Random Access Memory (RAM) 504 and a static memory 516.

The communications unit 502 may include one or more wired and/or wireless input/output (I/O) interfaces 509 that are configurable to communicate with other communication devices, such as the radios 140, 145, and 150, and the wireless RAN 115.

For example, the communications unit 502 may include one or more wireless transceivers 508, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 502 may additionally or alternatively include one or more wireline transceivers 508, such as an Ethernet transceiver, a USB transceiver, or similar transceiver configurable to communicate via a twisted pair wire, a coaxial cable, a fiber-optic link, or a similar physical connection to a wireline network. The transceiver 508 is also coupled to a combined modulator/demodulator 510.

The electronic processor 513 has ports for coupling to the display screen 505, the input device 506, the microphone 520, the imaging device 521, and/or the speaker 522. Static memory 516 may store operating code 525 for the electronic processor 513 that, when executed, performs one or more of the steps set forth in blocks 305-350 and accompanying text.

The static memory 516 may comprise, for example, a hard-disk drive (HDD), an optical disk drive such as a compact disk (CD) drive or digital versatile disk (DVD) drive, a solid state drive (SSD), a flash memory drive, or a tape drive, and the like.

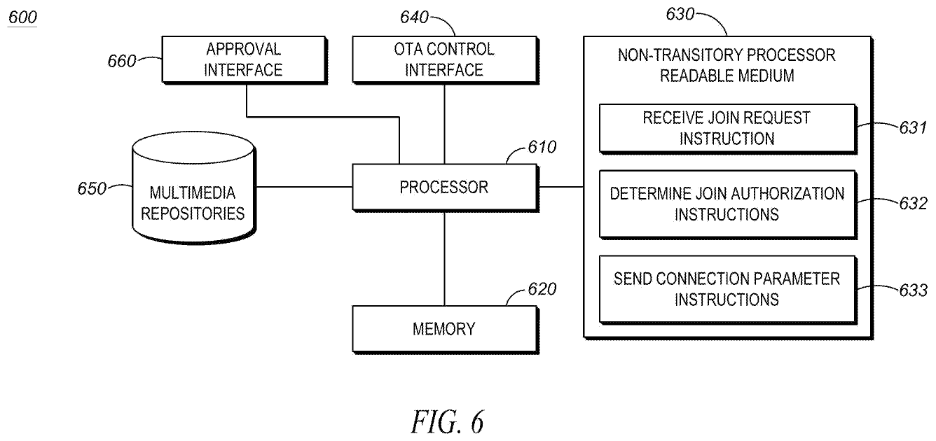

FIG. 6 is an example of a device 600 that may implement the communications network infrastructure. It should be understood that FIG. 6 represents one example implementation of a computing device that utilizes the techniques described herein. Although only a single processor is shown, it would be readily understood that a person of skill in the art would recognize that distributed implementations are also possible. For example, the various pieces of functionality described above (e.g. providing code plug information, storing subscriber data, etc.) could be implemented on multiple devices that are communicatively coupled. FIG. 6 is not intended to imply that all the functionality described above must be implemented on a single device.

Device 600 may include processor 610, memory 620, non-transitory processor readable medium 630, OTA Control interface 640, subscriber data 650, and approval interface 660.

Processor 610 may be coupled to memory 620. Memory 620 may store a set of instructions that when executed by processor 610 cause processor 610 to implement the techniques described herein. Processor 610 may cause memory 620 to load a set of processor executable instructions from non-transitory processor readable medium 630. Non-transitory processor readable medium 630 may contain a set of instructions thereon that when executed by processor 610 cause the processor to implement the various techniques described herein.

For example, medium 630 may include receive join request instructions 631. The receive join request instructions 631 may cause the processor to receive a join request from the first subscriber device. For example, the join request may be received over the OTA control interface 640 from the first subscriber device. The receive join request instructions 631 are described throughout this description generally, including places such as the description of blocks 405-415.

The medium 630 may include determine join authorization instructions 632. The join authorization instructions 632 may cause the processor to utilize the approval interface 660 to receive approval for joining the second subscriber device to the communications network. For example, the approval interface may be used to communicate with a supervisor radio or an authorization entity to determine if the foreign radio should be allowed to connect with the communications network. The join authorization instructions 632 are described throughout this description generally, including places such as the description of blocks 420-450.

The medium 630 may include send connection parameter instructions 633. The send connection parameter instructions 633 may cause the processor to send the connection parameters to the foreign radio via the home radio. The connection parameters may be sent to the home radio via the OTA control interface 640. In addition, information related to the foreign radio may be stored in the subscriber data 650 which may implement subscriber data 125. The send connection parameter instructions 633 are described throughout this description generally, including places such as the description of blocks 455 and 460.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot establish a wireless communications link between radios and/or a radio access network, among other features and functions set forth herein). Furthermore, the techniques described herein are integrated in the practical application of allowing a foreign radio to join a home communications network without requiring tedious interaction with the communications department of the home communications network.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving, at a first subscriber device, the first subscriber device registered with a communications network, a request from a second subscriber device to join the communications network, the second subscriber device not registered with the communications network, the request received via a wireless communications link;
sending, by the first subscriber device, a request to the communications network for authorization for the second subscriber device to join the communications network;
receiving, by the first subscriber device, from the communications network an authorization for the second subscriber device to join the communications network, the authorization including a set of connection parameters for joining the communications network; and
sending, by the first subscriber device, the set of parameters for joining the communications network to the second subscriber device, over the wireless link, wherein the second subscriber device uses the set of connection parameters to join the communications network.

2. The method of claim 1 further comprising:
authenticating the second subscriber device prior to receiving the request to join the communications network from the second subscriber device.

3. The method of claim 2 wherein authenticating the second subscriber device further comprises:
authenticating a user of the second subscriber device.

4. The method of claim 1 wherein the request from the second subscriber device to join the communications network includes at least one of a unit ID, a home system ID, and a role of a user of the second subscriber device.

5. The method of claim 1 wherein the set of connection parameters includes a default talkgroup, the default talkgroup based on a role of a user of the second subscribed device.

6. The method of claim 1 wherein the request to the communications network for authorization for the second subscriber device to join the communications network indicates to the communications network that the second subscriber device is authorized to join the communications network.

7. The method of claim 1 wherein the second subscriber device is not registered with any communications network.

8. A method comprising:
receiving, at a communications network, a request from a first subscriber device to provide a set of connection parameters to be utilized by a second subscriber device to join the communications network;
determining if the second subscriber device is authorized to join the communications network;
sending the set of connection parameters to the first subscriber device when it is determined that the second subscriber device is authorized to join the communications network, wherein the second subscriber device utilizes the set of connection parameters to join the communications network.

9. The method of claim 8 wherein determining if the second subscriber device is authorized to join the communications network further comprises:
sending an approval request to a third subscriber device, the third subscriber device associated with a user having a supervisory role; and
receiving a response from the third subscriber device, the response indicating if the second subscriber device is authorized to join the communications network.

10. The method of claim 8 wherein determining if the second subscriber device is authorized to join the communications network further comprises:
determining if the first subscriber device is associated with a user that is authorized to approve subscriber devices joining the communications network; and
authorizing the second subscriber device to join the communications network when it is determined that the user associated with the first subscriber device is authorized to approve subscriber devices joining the communications network.

11. The method of claim 8 wherein determining if the second subscriber device is authorized to join the communications network further comprises:
sending an approval request to a third party authorization entity; and
receiving a response from the third party authorization entity, the response indicating if the second subscriber device is authorized to join the communications network.

12. The method of claim 8 wherein the request from first subscriber device to provide the set of connection parameters to be utilized by a second subscriber device to join the communications network further comprises:
a role of a user associated with the second subscriber device; and
the set of connection parameters further comprises a default talkgroup for the user associated with the second subscriber device, the default talkgroup based on the role of the user associated with the second subscriber device.

13. The method of claim 8 wherein the set of connection parameters further comprises:
a subscriber ID associated with the communications network that is to be used by the second subscriber device when joining the communications network.

14. A non-transitory processor readable medium containing a set of instructions thereon that when executed by a processor cause the processor to:
receive, at a first subscriber device, the first subscriber device registered with a communications network, a request from a second subscriber device to join the communications network, the second subscriber device not registered with the communications network, the request received via a wireless communications link;
send, by the first subscriber device, a request to the communications network for authorization for the second subscriber device to join the communications network;
receive, by the first subscriber device, from the communications network an authorization for the second subscriber device to join the communications network, the authorization including a set of connection parameters for joining the communications network; and
send, by the first subscriber device, the set of parameters for joining the communications network to the second subscriber device, over the wireless link, wherein the second subscriber device uses the set of connection parameters to join the communications network.

15. The medium of claim 14 further comprising instructions to:
authenticate the second subscriber device prior to receiving the request to join the communications network from the second subscriber device.

16. The medium of claim 15 wherein authenticating the second subscriber device further comprises instructions to:
authenticate a user of the second subscriber device.

17. The medium of claim 14 wherein the request from the second subscriber device to join the communications network includes at least one of a unit ID, a home system ID, and a role of a user of the second subscriber device.

18. The medium of claim 14 wherein the set of connection parameters includes a default talkgroup, the default talkgroup based on a role of a user of the second subscribed device.

19. The medium of claim 14 wherein the request to the communications network for authorization for the second subscriber device to join the communications network indicates to the communications network that the second subscriber device is authorized to join the communications network.

20. The medium of claim 1 wherein the second subscriber device is not registered with any communications network.
